(19) United States
(12) Patent Application Publication
(10) Pub. No.: US 2012/0224764 A1
(43) Pub. Date: Sep. 6, 2012

(54) METHOD FOR COLOR RECOGNITION

(76) Inventor: CHI PEI WENG, Hsinchu (TW)

(21) Appl. No.: 13/039,323

(22) Filed: Mar. 3, 2011

(51) Int. Cl. G06K 9/62

(52) U.S. Cl. 382/159

(57) ABSTRACT

A color recognition method is provided, including a color learning phase and a color recognition phase. The color learning phase further includes the steps of: preparing a plurality of color images printed on at least a sheet of paper; for each color image of the plurality of color images, obtaining the digital signals representing the red, green and blue components of the color; associating the digital signals with an audio file related to the color image; and storing the digital signals with associated audio file to a database in the storage device. The color recognition phase further includes the steps of: obtaining the digital signals representing the red, green and blue components of an color image printed on a sheet of paper; comparing the digital signals representing the color image to a pre-stored database in a storage device; if a match is found, playing the associated audio file.

### FIELD OF THE INVENTION

The present invention generally relates to a method for color recognition, and more specifically to an economical color recognition method with learning capability, applicable to printed educational material.

### BACKGROUND OF THE INVENTION

Contemporary electronic education material utilizes a wide range of technologies to enrich the contents of the material so that children can learn different subjects in a more vivid manner. For example, color recognition technology combined with the audio output can teach a child to correctly the color of the objects printed on the teaching material. When a user places a reading device, such as, a pen-like device, on an image printed on the education material, the audio information related to the printed image can be outputted so that the user can listen to and learn from the audio content. In addition to education material, the same technology can also be used to products for vision-impaired users.

The conventional approach to implement color recognition in education material often relies on printing the image with special ink having micro-scale identification information, and then using charge-coupled device (CCD), electronic electron microscopy component, or optical identification (OID) component to read the micro-scale identification information in the printed image. This approach has several advantages. For example, this approach allows a plurality of objects printed in the same color on the same sheet, provides high identification rate, and is not easily affected by external light source. Also, micro-scale identification information is invisible to the naked eye, so that the privacy is maintained. However, this approach is expensive because special ink is required for printing, the printing process is more complex and the electronic reading device is also expensive. In addition, the electronic reading device cannot be used to identify the education material not printed with special ink. In other words, the electronic reading device can only work with the specially prepared material, not the general printed sheets. This would cost the parents extra if more education material is to be purchased. It is therefore, imperative to devise an economical color recognition method to lower the cost of manufacturing as well as meeting customer and the industrial needs.

### SUMMARY OF THE INVENTION

The primary object of the present invention is to provide an economical color recognition method.

An exemplar embodiment of the present invention is to provide a color recognition method, including a color learning phase and a color recognition phase. The color learning phase further includes the steps of: preparing a plurality of color images printed on at least a sheet of paper; for each color image of the plurality of color images, obtaining the digital signals representing the red, green and blue components of the color; associating the digital signals with an audio file related to the color image; and storing the digital signals with associated audio file to a database in the storage device. The color recognition phase further includes the steps of: obtaining the digital signals representing the red, green and blue components of an color image printed on a sheet of paper; comparing the digital signals representing the color image to a pre-stored database in a storage device; if a match is found, playing the associated audio file.

The associate audio file can contain the description of the color, the image or any other information related to the image for educational purpose. The audio file may be pre-prepared with the printed material, or recorded in accordance with the color learning phase. In other words, the learning capability of the present invention enables the user to turn any color printed material into an educational material instead of purchasing specially printed material.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a flowchart of the color recognition method according to the invention;

FIG. 2 shows a flowchart of the operation to obtain the digital signals representing the red, green and blue components of a color image according to the present invention;

FIG. 3 shows an exemplary color printed sheet according to the present invention; and

FIG. 4 shows a schematic view of a color recognition device applying the color recognition method according to the present invention.

### DETAILED DESCRIPTION OF THE PREFERRED EMBODIMENTS

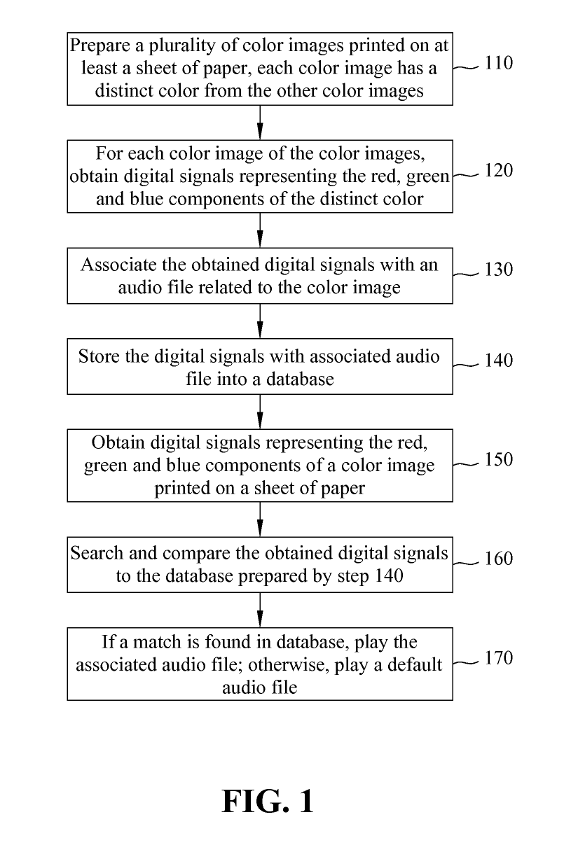

FIG. 1 shows a flowchart of a color recognition method according to the present invention. As shown in FIG. 1, a color recognition method of the present invention includes a color learning phase and a color recognition phase. The color learning phase includes steps 110-140, and the color recognition phase includes steps 150-170. The steps of the color learning phase are used to prepare a database of color image with associated audio files, and the database is later used in the color recognition phase.

As shown in FIG. 1, step 110 is to prepare a plurality of color images printed on at least a sheet of paper. Each printed color image on a sheet of paper must have a distinct color to distinguish itself from other color images. Step 120 is to obtain the digital signals representing the red, green and blue components of the distinct color of the color image for each color image. Step 130 is to associate the obtained digital signals with an audio file related to the color image, and step 140 is to store the digital signals with associated audio file to a database. At this point, the learning phase of the color recognition method is complete and the color database is prepared. In other words, the color database will have information on the digital signal representation of the color image with associated audio file. The audio file can be prepared along with the printed color image, or recorded by the user so that customized information can be associated with each color image.

Step 150 is to obtain the digital signals representing the red, green and blue components of a color image printed on a sheet of paper. Step 160 is to search the digital signals representing the color image in the color database prepared in step 140. Finally, in step 170, if a match is found in the database, the associated audio file is played; otherwise, a default audio file is played. The default audio file could deliver a standard message, such as, “the color is not found”, “there is no information on this image”, or simply silent.

It is worth noting that there are a plurality of approaches to obtain the digital signals representing the red, green and blue components of a color image, as required in step 120 and step 150. The present invention provides the following exemplary embodiment to implement the operation. However, the exemplary embodiment is for illustrative, and not restrictive purpose. The color recognition method of the present invention is also applicable to other equivalent implementation to provide the same functions.

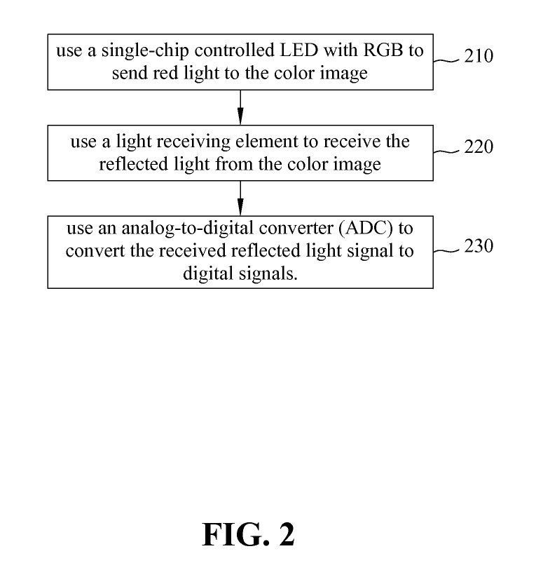

FIG. 2 shows a flowchart of the operation to obtain the digital signals representing the red, blue and green components of a color image according to the present invention. As shown in FIG. 2, step 210 is to use a single-chip controlled LED with RGB to send red light to color image, step 220 is to use a light receiving element to receive the reflected light from the color image, and step 230 is to use an analog-to-digital converter (ADC) to convert the received reflected light signal to digital signals. At this point, the digital signal representing the red component in the color of the color image is obtained. By repeating the above steps 210-230 for reach light color, i.e., send green light and blue light respectively to the same color image, the digital signals of all three color components of the color image can be obtained. After all the digital singles representing the blue, green and blue components of the color image are obtained, the digital signal representation can be used for association with an audio file and stored to the color database, as in the color learning phase, or can be used to search the color database to find matches, as in color recognition phase.

It is also worth noting that the color database can be further enhanced to structure the color and audio file association in a hierarchical manner so expand the capacity of the distinct color, for example, by categorization.

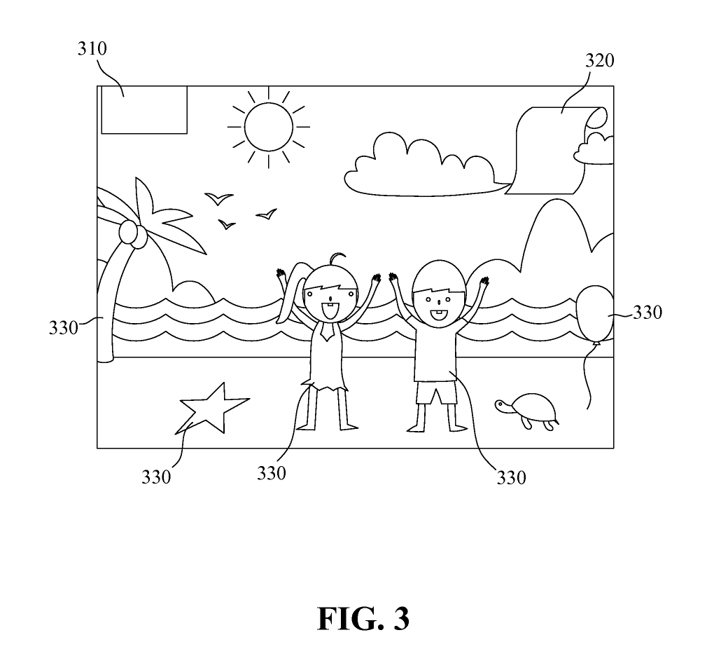

FIG. 3 shows a schematic view of an exemplary color printed sheet according to the invention. As shown in FIG. 3, the color printed sheet includes an image labeled “Beach” 310, an image labeled “Story” 320 and a plurality of unlabelled images 330, such as, a tree, a sea star, and so on. By arranging the color and audio file association in the database under, for example, the “Beach” category, the distinct colors used for images in the “Beach” color sheet can also be used in other images in other color sheets. In this manner, only the colors labeling the category, such as, “Beach” need to be distinct so that different color printed sheets would have distinct color label to differentiate from the others. Similarly, a sub-category, such as, “Story” can also be used to further expand the color capacity of the database or provide an overview of the contents on the color printed sheet. It is worth noting that the above exemplar is for illustrative, not restrictive purpose. Other similar enhancements are also within the scope of the present invention.

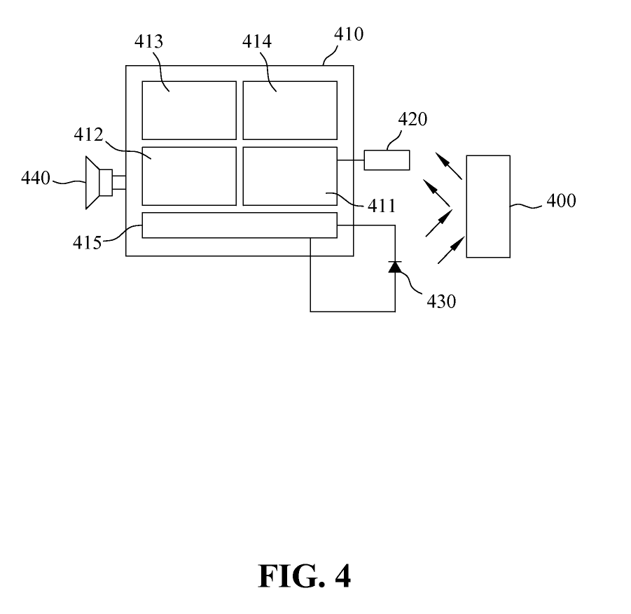

FIG. 4 shows a schematic view of a color recognition device according to the present invention. As shown in FIG. 4, the color recognition device includes a programmable audio single-chip 410, a light receiving element 420, an RGB LED 430, and a speaker 440. Programmable audio single chip 410 further includes an ADC 411, a voice and melody synthesizer 412, a microprocessor (MCU) 413, a memory 414, and an I/O controller 415. By pointing the color recognition device on an object 400, RGB LED 430 issues the light (red, green, and blue in sequence) to object 400, and light receiving element 420 receives the light reflected from object 400. ADC 411 of single-chip 410 further converts the reflected light into digital signals. Microprocessor 413 controls the entire operation, including light issuing, storing, searching and matching, playing audio file, and so on, and memory 410 is for storing the aforementioned color database.

In summary the present invention provides an inexpensive and economical alternative to color recognition so as to lower the cost for both the manufacturers and customers, while enabling the customer to customize any printed color sheet and turn into educational material.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A color recognition method, comprising a color learning phase and a color recognition phase, said color learning phase further comprising the steps of:
preparing a plurality of color images printed on at least a sheet of paper;
for each color image of said plurality of color images, obtaining digital signals representing red, green and blue components of said color image;
associating said digital signals with an audio file related to said color image; and
storing said digital signals with associated audio file to a database; and
said color recognition phase further comprising the steps of:
obtaining digital signals representing red, green and blue components of an color image printed on a sheet of paper;
comparing said digital signals representing said color image to said database; and
if a match being found, playing said associated audio file.

2. The method as claimed in claim 1, further comprising a step of playing a default audio file if no match being found after said step of if a match being found.

3. The method as claimed in claim 1, wherein said step of obtaining digital signals representing red, green and blue components of an color image printed on a sheet of paper further comprises steps of:
using a single-chip controlled LED with RGB to send red light to said color image;
using a light receiving element to receive reflected light from said color image;
using an analog-to-digital converter (ADC) to convert said received reflected light signal to digital signal; and
repeating above three steps for green light and blue light, respectively.

4. The method as claimed in claim 1, wherein said sheet of paper with printed color images comprises a color image with a distinct color able to be used for differentiating from other sheets of paper with printed color images.

5. The method as claimed in claim 4, wherein said database storing digital signals and audio file association can be structured in a hierarchical manner to use categories in accordance with said color image with a distinct color for differentiating other sheets of paper.
